(19) United States
(12) Patent Application Publication
(10) Pub. No.: US 2023/0156387 A1
(43) Pub. Date: May 18, 2023

(54) MICROPHONE SPEAKER WITH DUAL INDEPENDENT SOUND CHAMBERS

(71) Applicant: Kuo Su, Xuancheng (CN)

(72) Inventor: Kuo Su, Xuancheng (CN)

(21) Appl. No.: 17/454,641

(22) Filed: Nov. 12, 2021

(51) Int. Cl. H04R 1/08; H04R 1/02; H04R 7/18

(52) U.S. Cl. CPC H04R 1/08; H04R 1/02; H04R 7/18

(57) ABSTRACT

A microphone speaker with dual independent sound chambers is disclosed, including a housing, a microphone assembly arranged on the housing, a barrier that is formed in the housing and that divides the housing into two independent chambers, two speakers respectively embedded in two sides of the housing where the rear ends of the two speakers are respectively disposed in the two independent chambers, and two air holes that are defined in the side of the housing and that are respectively in communication with the two independent chambers, where the air flows generated when the speakers are sounding enter and exit the independent chambers through the respective air holes.

### TECHNICAL FIELD

This disclosure relates to a microphone speaker, and more particularly relates to a microphone speaker with dual independent sound chambers.

### BACKGROUND

A microphone speaker is an audio device with both sound collection and playback functions. In practical applications, for a microphone speaker with dual speakers, the two speakers are generally arranged symmetrically on both sides of the housing, and the rear ends of the two speakers are placed in the same chamber inside the housing. When the two speakers sound at the same time, the opposing airflows generated at the rear ends of the two speakers will collide and affect each other, thereby canceling some sound details, resulting in poor sound effects of the microphone speaker, making it difficult to meet user needs.

### SUMMARY

In view of the shortcomings of the related art, the technical problem to be solved by the disclosure is to provide a microphone speaker with dual independent sound chambers, which can avoid the adverse effects of the opposite airflows inside the housing and thus improve the sound effect.

In order to solve the above technical problem, the present disclosure adopts the following technical solutions.

There is provided a microphone speaker with dual independent sound chambers, including a housing and a microphone assembly arranged on the housing. A barrier is formed in the housing, and the housing is divided into two independent chambers by the barrier. Two speakers are respectively embedded in two sides of the housing, and the rear ends of the two speakers are respectively disposed in the two independent chambers. Two air holes are defined in the side of the housing, and are respectively communicated with the two independent chambers, and the air flows generated when the speakers are sounding enter and exit the independent chambers through the respective air holes.

In some embodiments, the housing includes a first joining housing and a second joining housing, which are opposed to each other and the two are joined and fixedly connected.

In some embodiments, the barrier includes a first partition and a second partition. The first partition is disposed in the first joining housing and the two are integrally formed, and the second partition is disposed in the second joining housing and the two are integrally formed. The edge of the first partition and the edge of the second partition abut against each other, and the connection between the first partition and the second partition is sealed and fitted.

In some embodiments, a diaphragm holder is fixed on the side of the housing, and a passive diaphragm is fixed on the diaphragm holder, and the passive diaphragm covers the outside of the two air holes.

In some embodiments, the side of the housing is provided with a recess, and the two air holes are both defined in the recess. The diaphragm holder is fixed at the edge of the recess, and the connection between the diaphragm holder and the recess is sealed and fitted, and the passive diaphragm covers the recess.

In some embodiments, the passive diaphragm and the two speakers are distributed in a triangular shape.

In the microphone speaker with dual independent sound chambers disclosed by this disclosure, the housing is divided into two independent chambers by the barrier, and then the two speakers are respectively inserted into the two independent chambers, and further the side of the housing is provided with two air holes for conducting airflow. When the speakers are working and sounding, the vibration generated will cause airflows to be generated in the independent chambers. The airflows enter and exit through the respective air holes so as to effectively avoid the cancellation of sound details due to the collision of the two rear end airflows, thus providing better sound effect of the microphone speaker with higher fidelity.

### BRIEF DESCRIPTION OF DRAWINGS

FIG. 1 is a three-dimensional view of a combined microphone speaker according to this disclosure.

FIG. 2 is a first schematic diagram in which the speaker body and the microphone assembly are in a split state.

FIG. 3 is a second schematic diagram in which the speaker body and microphone assembly are in a split state.

FIG. 4 is a first exploded view of the microphone assembly.

FIG. 5 is a second exploded view of the microphone assembly.

FIG. 6 is the internal structural diagram illustrating the connection between the speaker body and the microphone assembly.

FIG. 7 is an exploded view of the speaker body.

FIG. 8 is a first perspective view of the housing.

FIG. 9 is a second perspective view of the housing.

FIG. 10 is an exploded view of the housing.

FIG. 11 is a schematic diagram illustrating the structures of the housing and the passive diaphragm.

### DETAILED DESCRIPTION

The present disclosure will now be described in greater detail in connection with the accompanying drawings and specific embodiments.

### Embodiment 1

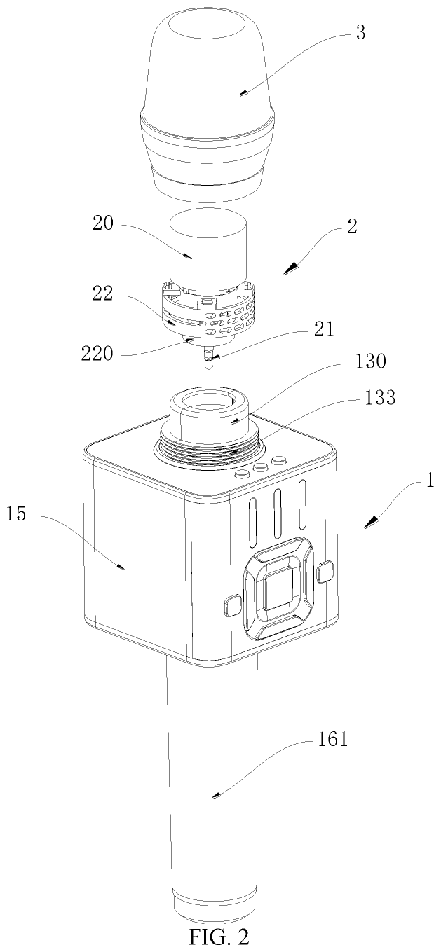

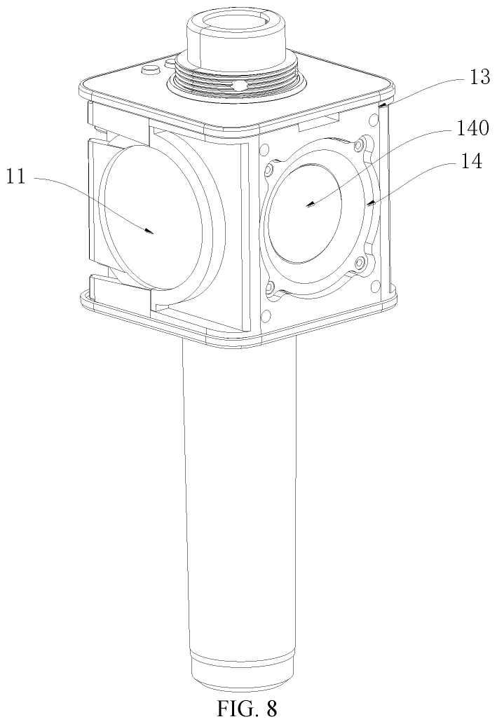

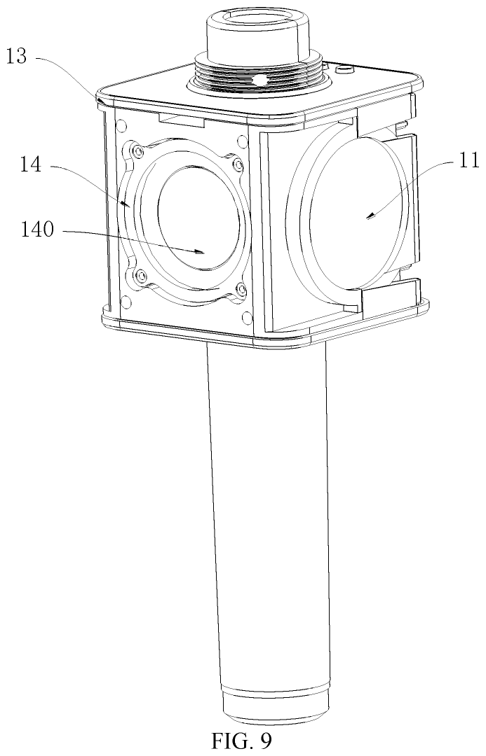

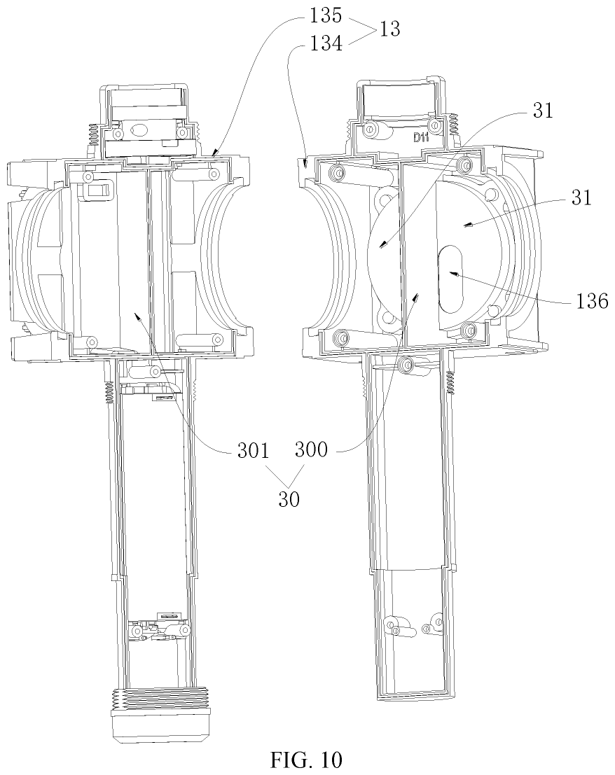

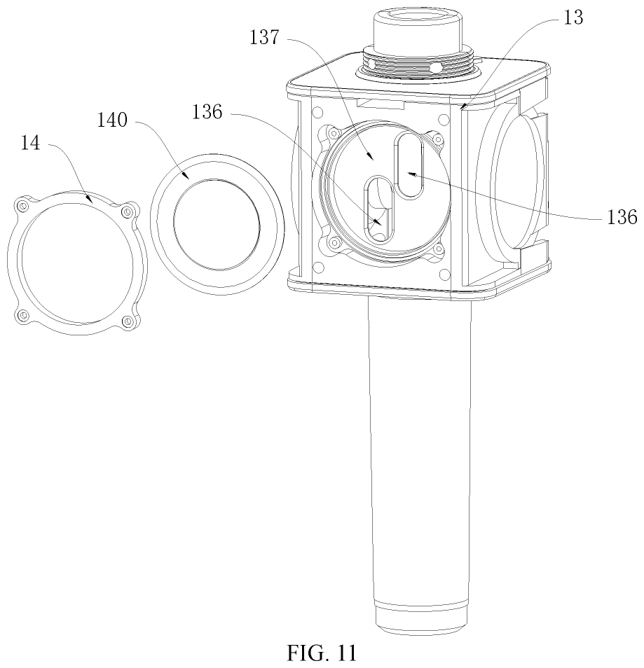

This embodiment provides a microphone speaker with dual independent sound chambers as illustrated in FIGS. 2 and 8 to 11, including a housing 13 and a microphone assembly 2 arranged on the housing 13. A barrier 30 is formed in the housing 13, and the housing 13 is divided into two independent chambers 31 by the barrier 30. Two speakers 11 are respectively embedded in two sides of the housing 13, and the rear ends of the two speakers 11 are respectively disposed in the two independent chambers 31. Two air holes 136 are defined in the side of the housing 13, and are respectively communicated with the two independent chambers 31, and the air flows generated when the speakers 11 are sounding enter and exit the independent chambers 31 through the respective air holes 136.

In the above structure, the housing 13 is divided into two independent chambers 31 by the barrier 30, and then the two speakers 11 are respectively inserted into the two independent chambers 31, and further the side of the housing 13 is provided with two air holes 136 for conducting airflow. When the speakers 11 are working and sounding, the vibration generated will cause airflows to be generated in the independent chambers 31. The airflows enter and exit through the respective air holes 136 so as to effectively avoid the cancellation of sound details due to the collision of the two rear end airflows, thus providing better sound effect of the microphone speaker with higher fidelity.

Regarding the specific structure of the housing 13, in this embodiment, the housing 13 includes a first joining housing 134 and a second joining housing 135, and the first joining housing 134 and the second joining housing 135 are opposite to each other and are fixedly connected.

As a illustrative implementation, the barrier 30 includes a first partition 300 and a second partition 301. The first partition 300 is disposed in the first joining housing 134 and the two are integrally formed, and the second partition 301 is disposed in the second joining housing 135 and the two are integrally formed. The edge of the first partition 300 and the edge of the second partition 301 abut against each other, and the connection between the first partition 300 and the second partition 301 is sealed and fitted.

In this embodiment, the partition of the cavity is achieved by setting two partitions, but this is only a illustrative embodiment of the present disclosure. In practical applications, the partition can also be replaced with a piece of soft material that can block airflow, such as a silicone sheet, etc., and these structures can achieve the function of blocking airflow. Therefore, no matter which form is replaced, as long as it has the function of partitioning the cavity, it shall fall in the scope of protection of the present disclosure.

In order to further improve the sound effect, in this embodiment, a diaphragm holder 14 is fixed on the side of the housing 13, and a passive diaphragm 140 is fixed on the diaphragm holder 14, and the passive diaphragm 140 covers the outside of the two air holes 136.

Since the passive diaphragm 140 covers the two air holes 136, when air flows in and out of the air holes 136, it will directly act on the passive diaphragm 140. Under the follow-up action of the passive diaphragm 140, it helps improve the bass effect of the microphone speaker.

In order to facilitate the installation of the diaphragm holder 14 while avoiding the passive diaphragm 140 from contacting the housing 13, in this embodiment, the side of the housing 13 is provided with a recess 137 and two air holes 136 are both defined in the recess 137. The diaphragm holder 14 is fixed at the edge of the recess 137, and the connection between the diaphragm holder 14 and the recess 137 is sealed and fitted, and the passive diaphragm 140 covers the recess 137.

As a illustrative implementation, the passive diaphragm 140 and the two speakers 11 are distributed in a triangular shape.

### Embodiment 2

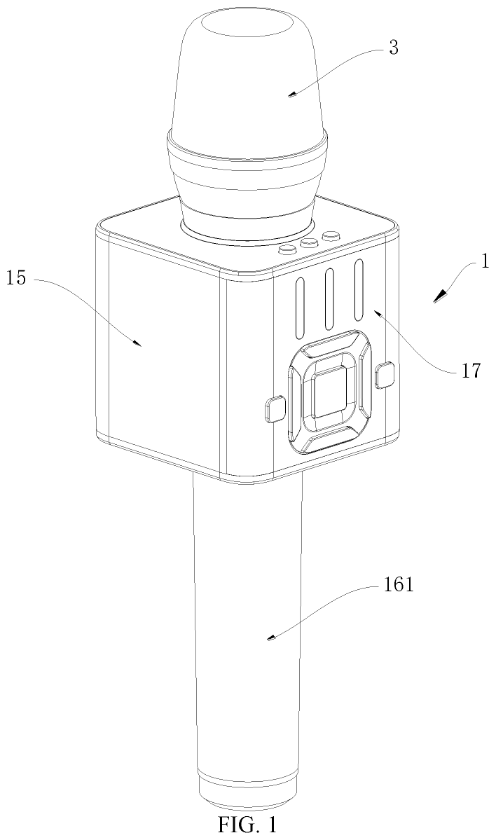

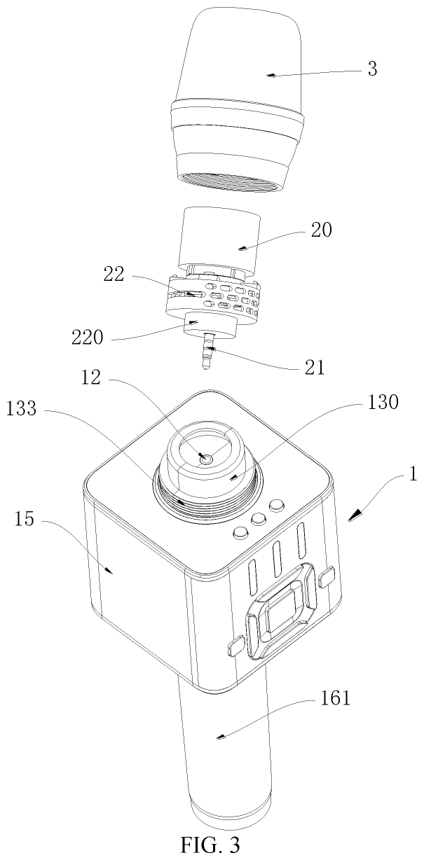

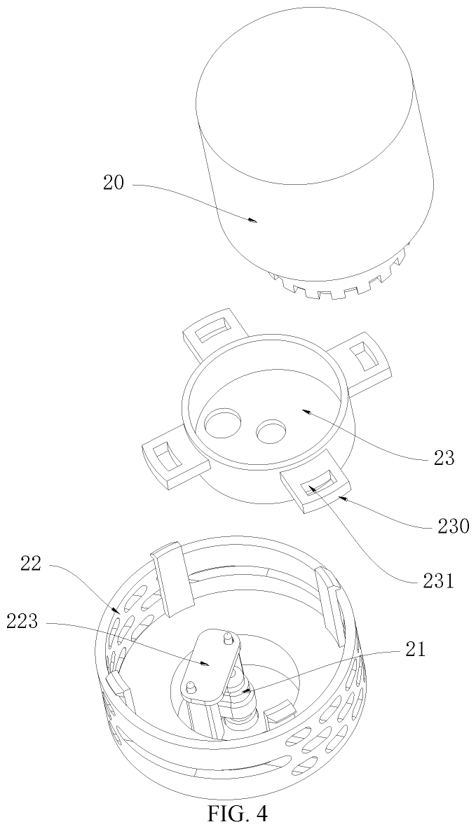

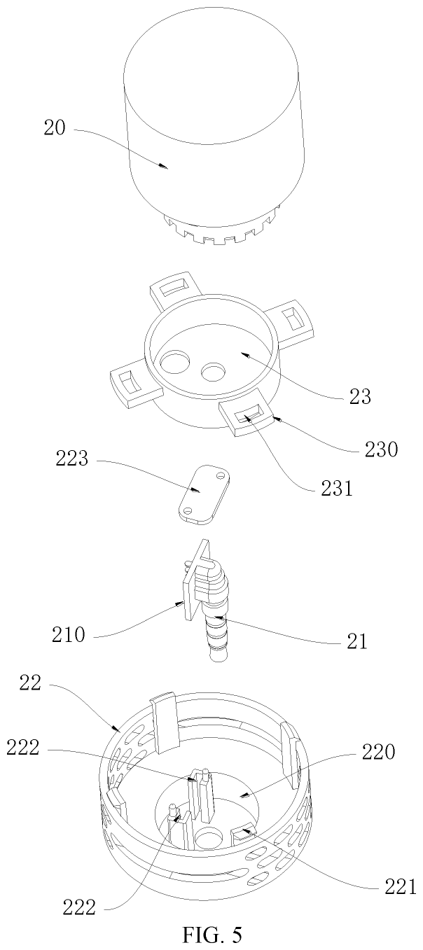

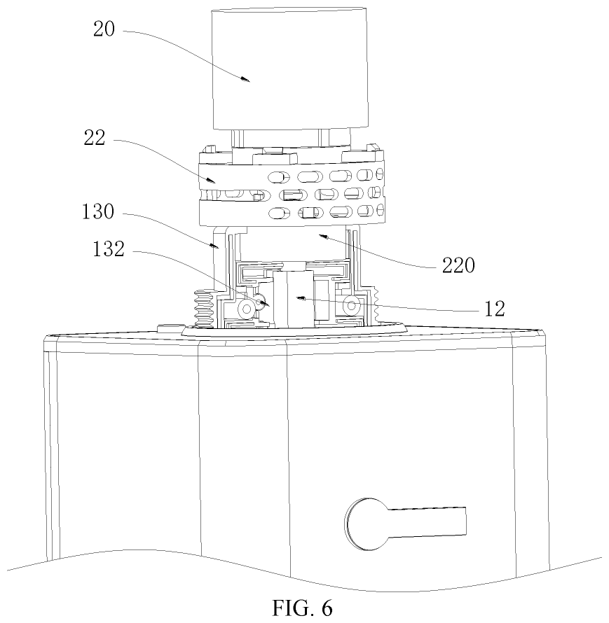

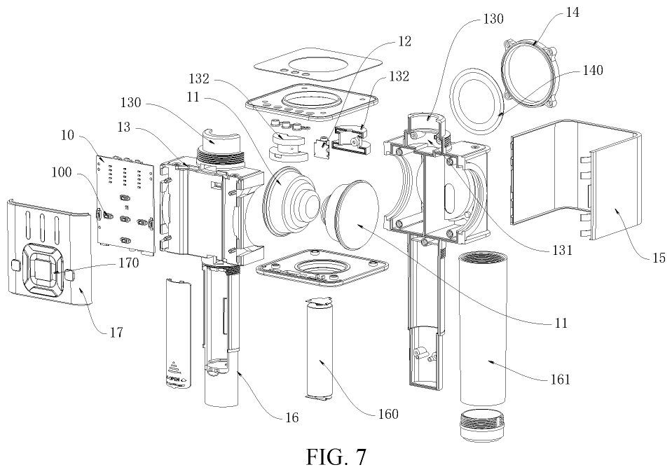

This embodiment proposes a combined microphone speaker. As illustrated in FIG. 1 to FIG. 7, it includes a speaker body 1 and a microphone assembly 2, in which:

the speaker body 1 includes a circuit board 10, a speaker 11, and a first connector 12, where the speaker 11 and the first connector 12 are each electrically connected to the circuit board 10;

the microphone assembly 2 includes a microphone head 20 and a second connector 21 electrically connected to the microphone head 20;

the microphone assembly 2 is detachably fitted with the speaker body 1, and when the microphone assembly 2 is installed in the speaker body 1, the second connector 21 is electrically connected to the first connector 12.

In the above microphone speaker, the speaker body 1 and the microphone assembly 2 are designed as a detachable combined structure. When the user needs to use the microphone speaker as a whole, the microphone assembly 2 needs to be installed on the speaker body 1. Furthermore, through the fitting of the second connector 21 and the first connector 12, the microphone head 20 and the circuit board 10 can maintain electrical contact. When the user only needs to use the speaker function, the microphone assembly 2 can be removed, and the first connector 12 or the built-in Bluetooth module of the circuit board 10 can be used to receive audio signals, thereby independently achieving the sound playback function. Compared with the related art, the present disclosure can flexibly disassemble and assemble the speaker body and microphone assembly depending on user needs, so as to meet various requirements such as independent use and combined use of the speaker body and microphone assembly. In addition, when the speaker body or microphone assembly is damaged, the repair can be completed by only replacing the speaker body or microphone assembly, which not only facilitates maintenance, but also avoids wasting resources due to the overall scrap of the microphone speaker, which better satisfies the user needs and market demands.

In this embodiment, the microphone assembly 2 includes a microphone support 22, which disposed on the microphone support 22, and the second connector 21 is fixed to the bottom of the microphone support 22. The speaker body 1 includes a housing 13, and the microphone support 22 is detachably fitted with the housing 13.

Further, a insert post 220 is formed at the bottom of the microphone support 22, a sleeve 130 is formed on the top of the housing 13, and the insert post 220 is inserted into the sleeve 130 and the two are closely fitted.

In the above structure, it is preferable to adopt a plug-in method to achieve fixed fitting. The plug-in insert post 220 and the sleeve 130 can be detachably connected by a tight fit or an interference fit. Of course, it is not limited to this in the actual application process. As an extended application, this embodiment can also be replaced with: the insert post 220 and the sleeve 130 are detachably connected by screw fitting or magnetic attraction fitting. When using magnetic attraction, the upper and lower magnets must be magnetically shielded except for the magnetic attraction surface to avoid adverse effects on the microphone and speakers.

In order to support the microphone head 20 while avoiding noise, in this embodiment, the microphone head assembly 2 includes an elastic bracket 23, and the microphone head 20 is fixed to the elastic bracket 23, and the elastic bracket 23 is fixed to the microphone support 22.

In order to support and secure the elastic bracket 23, in this embodiment, a plurality of lugs 230 are formed at the edge of the elastic bracket 23, and the lugs 230 are provided with clamping holes 231. A plurality of hooks 221 are formed on the microphone support 22, and the hooks 221 are aligned with the lugs 230 one by one. The hooks 221 are clamped in the respective clamping holes 231 so that the elastic bracket 23 and the microphone support 22 are clamped and fitted.

The above clamping method is not only convenient for disassembly and assembly, but also has a simple structure and does not rely on screw fixation, which helps to save the number of parts.

As a illustrative implementation, the present embodiment further includes a net cover 3, and a threaded portion 133 is formed at the bottom of the sleeve 130. The net cover 3 is arranged on the outside of the microphone head assembly 2 and the sleeve 130. The opening of the net cover 3 is screwed and fixed with the threaded portion 133.

Under the action of the net cover 3, it not only protects the microphone head assembly 2, but also covers the microphone head assembly 2 and the sleeve 130 as a whole, making the overall combined structure of the microphone speaker more reliable.

In order to better fix the second connector 21, in this embodiment, the insert post 220 is hollow, and two oppositely arranged vertical grooves 222 are formed on the inner side of the insert post 220. A wiring board 210 is fixed at the end of the second connector 21, and both side edges of the wiring board 210 are respectively clamped in the two vertical grooves 222. The tops of the two vertical grooves 222 are fixed to a pressure plate 223, which clamps the wiring board 210 in the two vertical grooves 222.

In fact, during the plugging process, the second connector 21 will receive a certain pushing force. Under the clamping action of the pressure plate 223, the second connector 21 can be more stably installed on the inner side of the insert post 220 thus avoiding loosening caused by external forces.

In order to better fix the first connector 12, in this embodiment, a cavity 131 is formed under the sleeve 130, and two oppositely arranged clamping sockets 132 are arranged in the cavity 131. The first connector 12 is sandwiched between the two clamping sockets 132, and the first connector 12 is fixed to the housing 13 by the two clamping sockets 132.

Further, the speaker body 1 includes two speakers 11, which are symmetrically fixed to the housing 13. A diaphragm holder 14 is embedded in the housing 13, and a passive diaphragm 140 is fixed to the diaphragm holder 14, where the passive diaphragm 140 and the two speakers 11 are distributed in a triangular shape. The passive diaphragm 140 can significantly improve the sound effect of the speaker body.

Regarding other illustrative structures of the present disclosure, in this embodiment, a mesh cover 15 is fixed to the outside of the housing 13, and the mesh cover 15 covers the outside of the speakers 11 and the passive diaphragm 140;

The circuit board 10 includes a Bluetooth module for receiving Bluetooth signals;

A handle 16 is formed at the bottom of the housing 13, and a battery 160 for supplying power to the circuit board 10 is provided in the handle 16, and a handle sleeve 161 is sleeved on the outer side of the handle 16, and the handle sleeve 161 is screwed and fixed with the handle 16;

A panel 17 is fixed to the outside of the housing 13, a plurality of keycaps 170 are provided on the panel 17, the circuit board 10 is arranged opposite to the panel 17, and the circuit board 10 is provided with a plurality of keys 100 for inputting control instructions, the keys 100 are aligned with the keycap 170 in one-to-one correspondence;

The first connector 12 is an audio socket, the second connector 21 is an audio plug, and the second connector 21 passes through the insert post 220 and extends downward. As an alternative implementation of the present disclosure, the first connector 12 and the second connector 21 may also be other types of connectors, such as contact type connectors.

The foregoing merely portrays some illustrative embodiments according to the present disclosure, which are not used to limit the present disclosure. Any modification, equivalent replacement or improvement made without departing from the technical scope of the disclosure shall all be included in the scope of protection of this disclosure.

What is claimed is:

1. A microphone speaker with dual independent sound chambers, comprising:
a housing;
a microphone assembly, arranged on the housing;
a barrier, formed in the housing so that the housing is divided into two independent chambers;
two speakers, respectively embedded in two sides of the housing, wherein rear ends of the two speakers are respectively arranged in the two independent chambers; and
two air holes, defined in a side of the housing and in communication with the two independent chambers, respectively, wherein air flows generated when the two speakers are sounding enter and exit the respective independent chambers through the respective two air holes.

2. The microphone speaker with dual independent sound chambers as recited in claim 1, wherein the housing comprises a first joining housing and a second joining housing, which are opposite to each other and are joined together and fixedly connected.

3. The microphone speaker with dual independent sound chambers as recited in claim 2, wherein the barrier comprises a first partition and a second partition, wherein the first partition is disposed in the first joining housing and the two are integrally formed, and the second partition is disposed in the second joining housing and the two are integrally formed, wherein an edge of the first partition and abuts against an edge of the second partition, and the connection between the first partition and the second partition is sealed and fitted.

4. The microphone speaker with dual independent sound chambers as recited in claim 1, wherein a diaphragm holder is fixedly arranged on a side of the housing, and a passive diaphragm is fixed to the diaphragm holder, wherein the passive diaphragm covers an outside of the two air holes.

5. The microphone sound box with dual independent sound chambers as recited in claim 4, wherein a recess is defined in the side of the housing, and the two air holes are both defined in the recess, wherein the diaphragm holder is fixed at an edge of the recess, and the connection between the diaphragm holder and the recess is sealed and fitted, and wherein the passive diaphragm covers the recess.

6. The microphone speaker with dual independent sound chambers as recited in claim 5, wherein the passive diaphragm and the two speakers are distributed in a triangular shape.
